(19) United States
(12) Patent Application Publication
(10) Pub. No.: US 2014/0197020 A1
(43) Pub. Date: Jul. 17, 2014

(54) SYSTEM AND PROCESS FOR PREPARING ACTIVE CARBON FROM COAL FLYASH

(71) Applicant: Minqing Xu, Longyan City (CN)

(72) Inventor: Minqing Xu, Longyan City (CN)

(73) Assignee: FUJIAN LONGYAN LONGNENG FLYASH COMPREHENSIVE UTILIZATION CO.LTD., Longyan City, Fujian (CN)

(21) Appl. No.: 14/125,257

(22) PCT Filed: Dec. 29, 2011
(86) PCT No.: PCT/CN2011/084880

§ 371 Date: Feb. 13, 2014

(30) Foreign Application Priority Data
Jun. 13, 2011 (CN) 201110157448.0
Jun. 13, 2011 (CN) 201110158168.1
Jun. 14, 2011 (CN) 201110158851.5
Jun. 14, 2011 (CN) 201110158853.4

(51) Int. Cl. C01B 31/08; C10B 49/04; C10B 47/24

(52) U.S. Cl. CPC C01B 31/081; C10B 47/24; C01B 31/088; C10B 49/04
USPC 201/16; 110/230; 432/107; 432/117

(57) ABSTRACT

The present invention provides a system and a process for preparing activated carbon from fly ash. The system of the present invention comprises a flotation system and a carbonization system. The present invention has the following advantages. Firstly, since a fuel gas-flue gas loop structure is arranged, the combustible fuel gas produced in carbonization process enters the combustion means for combustion via this loop structure, and also via this loop structure, the high temperature flue gas generated by the combustion enters the carbonization furnace to heat up and carbonize the charcoal powder raw material within the carbonization furnace. Such a solution not only saves energy, but also prevents a substantial amount of combustible gas from being emitted to the atmosphere, thereby reducing environmental pollution. Secondly, since two cylinders are arranged in the carbonization furnace, the charcoal powder raw material in the inner cylinder enters the outer cylinder and then exits from the outer cylinder. In this way, with the length of the device unchanged, the route of the charcoal powder raw material is lengthened and its heating time is prolonged, so that the raw material is sufficiently heated and carbonized.

### FIELD OF THE INVENTION

This invention relates to a system and a process for the preparation of activated carbon from fly ash, and more particularly, the present invention relates to a system and a process for the preparation of activated carbon from fly ash by means of flotation and carbonization.

### BACKGROUND OF THE INVENTION

Fly ash is one of the main wastes produced by electricity generating plants. However, fly ash contains large amounts of unburned carbon particles, which, after flotation, can be used as a raw material for manufacturing activated carbon.

Carbonization process is one of the important processes for producing activated carbon by means of gas activation. This process isolates the raw material from the air and heat up the raw material to reduce its non-carbon elements, so as to produce a carbonaceous material suitable for the activation process. Carbonization process is a major preparative step and a groundwork for the activation process. In the process of producing coal-based activated carbon, the carbonization process usually includes two parts: carbonization of the material and treatment of tail gas after the carbonization.

Carbonization process produces combustible flue gas of organics. Unfortunately, the prior art does not provide a desirable solution for the treatment of the flue gas, and discharging it into the atmosphere is a pollution to the environment and is also a waste of useful resources.

The prior art does not yet provide a desirable system for preparing activated carbon from fly ash by means of flotation and carbonization.

### SUMMARY OF THE INVENTION

To overcome the above disadvantage of the prior art, it is an object of the present invention to provide a system and a process for preparing activated carbon from fly ash by means of flotation and carbonization, which can save resources and reduce environmental pollution.

As one aspect of the present invention, a system is provided for preparing activated carbon from fly ash by means of flotation and carbonization, which comprises a flotation system and a carbonization system. The flotation system comprises at least one flotation device and each flotation device includes a vertically arranged cylinder, an overflow collection segment disposed at the top of the cylinder and a tailing collection segment disposed at the bottom of the cylinder, in which the overflow collection segment is provided with a discharge port while the tailing collection segment is provided with a tailing outlet.

The carbonization system of the present invention comprises:

a combustion means having a gas inlet and a gas outlet;
a double-cylinder rotary carbonization furnace, comprising a rotatable inner cylinder, a rotatable outer cylinder, a heating means disposed in the inner cylinder, a drive means for driving the inner cylinder and the outer cylinder to rotate, the inner cylinder being sheathed by the outer cylinder;
a fuel gas-flue gas loop structure in which the fuel gas produced by the heated charcoal powder raw material in the carbonization furnace is conveyed to the combustion means for combustion, and the flue gas produced by the fuel gas is used to heat up the charcoal powder raw material, with the loop structure comprising a plurality of openings arranged at the carbonization furnace and a gas conduit for connecting the carbonization furnace to the combustion means.

The term “charcoal powder raw material” in the present invention refers to the raw material for carbonization in the carbonization furnace. It can be a carbonaceous material in the form of particles, e.g. carbonaceous particles obtained from fly ash flotation.

The term “fuel gas” in the present invention refers to combustible gas generated from the heated charcoal powder raw material. Fuel gas can comprise various volatile components such as CO, H2, CH4, alkane, alkene and coal tar. Meanwhile, the term “flue gas” refers to gas generated by the combustion of fuel gas in the combustion means.

In the present invention, the rotation direction of the inner cylinder and the outer cylinder within the carbonization furnace can be the same or can be the opposite. Preferably, the outer cylinder and the inner cylinder are coaxial.

The axis of the outer cylinder and the inner cylinder can be horizontal or having a slight angle with the horizontal plane, e.g. an angle of 5°-8°. The outer cylinder and the inner cylinder are driven to rotate by the drive means, so that the charcoal powder within the cylinders are uniformly and sufficiently heated.

The combustion means (e.g., a combustion furnace) is disposed outside the carbonization furnace, and is communicated with the carbonization furnace via the gas conduit. A gas pump can be provided at the intermediate part of the gas conduit, so that, being pumped by the gas pump, the fuel gas, which is generated during the carbonization process of the charcoal powder raw material within the carbonization furnace, enters the gas inlet of the combustion means via the gas conduit, and combusts within the combustion means. The combustion generates high temperature flue gas. The high temperature flue gas enters the carbonization furnace via the gas conduit. At this moment, the heating means is switched off, and the charcoal powder raw material within the carbonization furnace is heated up by the high temperature flue gas and is carbonized. Fuel gas generated by the carbonization in turn is pumped back to the combustion means for combustion and again generates high temperature flue gas, and the cycle repeats.

Since a fuel gas-flue gas loop structure is arranged, the combustible fuel gas produced in the carbonization process enters the combustion means for combustion via this loop structure, and the high temperature flue gas generated by the combustion enters the carbonization furnace via this loop structure to heat up and carbonize the charcoal powder raw material within the carbonization furnace. Such a technical solution not only saves energy, but also prevents a substantial amount of combustible gas from being emitted to the atmosphere, thereby reducing environmental pollution.

According to an embodiment of the present invention, the flotation device further comprises:

a gas-diffuser disposed within the cylinder; the gas-diffuser being formed with a large surface for reflecting bubbles and particles; the surface of the gas-diffuser being formed with a plurality of air holes; the plurality of air holes being arranged to have different angles with the horizontal plane so that turbulent flow of materials is created within cylinder;
spaced multiple-layer flotation plates in the cylinder; the flotation plates being formed with a plurality of holes; the flotation plates having two functions: for stratifying different materials with different floatage, and for limiting the size of bubbles by the diameter of the holes on the flotation plates; the diameter of the holes on the flotation plate being 0.5 cm-5 cm; The flotation plates can be made of metal, plastics or other materials, and specifically, the flotation plates can comprise only one layer or multiple layers, e.g. 2-5 layers, wherein the bottom layer of the flotation plates is disposed above the gas-diffuser;
a dispensing means disposed on the upper part of the overflow collection segment; the dispensing means being a vessel which has a plurality of dispensing pipes at its lower part or bottom, the ends of the dispensing pipes being arranged between the gas-diffuser and the bottom layer of the flotation plates;
a gas supply means, the gas supply means being communicated with a plurality of holes on the gas-diffuser via a first gas conduit.

According to an embodiment of the present invention, in at least one flotation device, the gas-diffuser is a cone-shaped gas-diffuser with an upward tip, the conic surface of the gas-diffuser being formed with a plurality of air holes. The purposes of arranging a conic gas-diffuser are that: firstly, bubbles containing carbon particles are reflected towards more angles by the cone-shaped gas-diffuser, thereby providing better reflection than a plane reflector; secondly, the gas-diffuser ejects gas, driving the bubbles to diffuse and float in a state of turbulent flow so that better flotation effect is achieved; and thirdly, bubbles that do not pass through the flotation plates are reflected by the cone-shaped gas-diffuser, thereby intensifying the turbulence and improving flotation rate. According to an embodiment of the present invention, in order to achieve a better reflection, the cone angle of the cone-shaped gas-diffuser is 60°-150° (a cone angle is an angle between the two crossed lines of the sectional surface of the thru axis and the conic surface). Different cone angles can be selected for processing different materials; for example, a cone angle of 90° can be selected for processing CFB fly ash.

According to another embodiment of the present invention, in at least one flotation device, the cylinder comprises a narrower first flotation segment in the upper part of the cylinder and a wider second flotation segment in the lower part of the cylinder. The overflow collection segment is disposed outside the first flotation segment and the bottom of the overflow collection segment is below the top of the first flotation segment, so that particles overflowed from the flotation segment are collected. For example, the overflow collection segment can be a cylindrical vessel with holes on its the bottom plate, and the top of the first flotation segment pierces through the holes on the bottom plate of the overflow collection segment, so that particles which have undergone flotation in the flotation segment continuously stack up to cross the cylindrical wall of the flotation segment and flow into the overflow collection segment. Another example is that, the external wall of the top of the first flotation segment is provided with overflow holes or overflow pipes, and the overflow collection segment is a vessel disposed below the overflow holes or overflow pipes. Particularly, between the first flotation segment and the second flotation segment there is disposed with a divergent cone segment as a transitional region, and the divergent cone segment is disposed above the bottom layer of the flotation plates, specifically, between the two layers of the flotation plates, e.g. between the bottom layer of the flotation plates and its adjacent upper layer. By arranging a divergent cone segment, the flotation device has more reflective area, allowing bubbles dashing up from below to decelerate and adjust their moving directions. Such an arrangement is advantageous in that, firstly, the turbulent flow of bubbles is intensified by the reflection; and secondly, bubbles are prevented from dashing towards the top of the flotation device along the cylindrical wall to make the overflow surface at the top uneven.

According to another embodiment of the present invention, in at least one flotation device, the gas supply means is connected with one or more second gas conduits, the second gas conduits leading into the dispensing means or being connected with the dispensing pipes. For example, the second gas conduit can be one conduit leading into the dispensing means; it can also be a plurality of conduits respectively connected with each of the dispensing pipes. Furthermore, the entire system can also be provided with only one gas supply means, the gas supply means conveying gas to the reflective gas-diffuser and the dispensing means in the flotation device of different stages via different pipelines. In this way, fly ash particles within the dispensing means are driven and accelerated by the gas to enter the cylinder via the dispensing pipes, thus improving the efficiency of flotation. Compared to the prior art solutions in which materials in the dispensing means are driven to flow downward by the negative pressure generated in a venturi tube, the present solution conveys high pressure gas by a gas conduit. This solution not only reduces power consumption, but also allows gas pressure to be regulated according to the amount and the viscosity of the materials, thereby improving product fineness.

According to another embodiment of the present invention, at least one flotation device further comprises a physical separation means disposed on the cylindrical wall or on the gas-diffuser. By arranging a physical separation means, the bonding between carbon particles and ash contents are effectively disrupted, thereby substantially improving carbon flotation rate. Particularly, the physical separation means can be a ultrasonic separation means or a ultrasonic breakup means to help promote the separation of carbon particles from ash contents by means of emitting ultrasonic waves, so that, for example, ultrafine carbon particles with a mesh number of up to 10,000 are formed. Specifically, the ultrasonic separation means or the ultrasonic breakup means comprises a ultrasonic wave transmitter and supplementary auxiliary means.

Furthermore, there can be one flotation device or a plurality of flotation devices in the flotation system provided by the present invention. A plurality of flotation devices can allow fly ash particles to undergo several stages of flotation. For example, the flotation system can be a two-stage flotation system, comprising two flotation devices, wherein the discharge port of the first flotation device is connected with a discharge pipe, the discharge pipe leading to a second flotation device. That is to say, the product of the first flotation device can be used as a raw material for further flotation in the second flotation device.

According to another embodiment of the present invention, the fuel gas-flue gas loop structure comprises a first opening at the head portion of the inner cylinder, a second opening at the end portion of the inner cylinder, a third opening at the end portion of the outer cylinder; the second opening being sheathed by the outer cylinder.

There can be a plurality of second openings. For example, they are formed on the same longitudinal cross-section having an equal distance from the end of the inner cylinder. All second openings are sheathed by the outer cylinder.

The charcoal powder raw material firstly enters the cylinder from the first opening of the inner cylinder, and under the rotation of the inner cylinder, the charcoal powder raw material flows to the second opening and enters the outer cylinder via the second opening. The fuel gas-flue gas can have co-current contacts or counter-current contacts with the charcoal powder raw material. When having co-current contacts, combustible gas generated by the heated charcoal powder raw material flows from the third opening out of the carbonization furnace, and enters the combustion means for combustion; the high temperature flue gas generated by the combustion of the combustible gas enters the carbonization furnace from the first opening, and flows to the third opening via the second opening. In the present invention, the contacts are preferably co-current contacts.

According to still another embodiment of the present invention, the gas conduit comprises a first gas conduit which is communicated with the first opening, and a second gas conduit which is communicated with the third opening; the other end of the first gas conduit leads to the gas inlet or gas outlet of the combustion means, and the other end of the second gas conduit leads to the gas outlet or gas inlet of the combustion means.

The floated and carbonized fly ash particles would have to be activated before used for preparing activated carbon. A suitable activation furnace for the system of the present invention can be, for example, a SLEP activation furnace which uses water vapor for activation, or various alkali activation furnaces which use alkali for activation. When a SLEP activation furnace is used, the pressure of water vapor within the furnace is 1-3 atmospheres (gauge pressure), and temperature within the furnace is about 950-1050° C.

According to yet another embodiment of the present invention, the system further comprises an alkali activation system which uses alkali for activation. This activation system follows after the carbonization system and comprises:

a nitrogen supply means, the nitrogen supply means being communicated with the nitrogen gas inlet of the activation furnace via a first connection conduit;
an activation furnace, the activation furnace being a sealed vessel in which a heating means is provided, the activation furnace comprising a first gas outlet and a nitrogen gas inlet, wherein the nitrogen gas inlet is formed with a nitrogen gas curtain and the first gas outlet is connected with a second connection conduit;
a first recovery unit, the first recovery unit being a sealed vessel in which absorption liquid is provided, the second connection conduit being inserted into the first recovery unit and extending below the liquid level of the absorption liquid, and a gas outlet being provided above the liquid level of the absorption liquid.

The activation system of the present invention is suitable for the activation reaction of an alkali activator. For example, if potassium hydroxide is used as an activator, its reaction with the carbon particles at a high temperature is:

KOH+C→K2CO3+K2O+H2

KOH, K2CO3 and K2O etch individual graphite micro-crystals or microcrystalline group to form pores of different sizes. Micro-molecular gases generated by the reaction during the activation process, e.g. CO [symbol] CO2 [symbol] H2 [symbol] H2O [symbol] H2S etc., flow out along existing pore passages, and during this process, the pores are expanded due to heat expansion. Furthermore, metallic potassium vapor is generated in the activation process. The metallic potassium vapor enters the graphite interlayer to form new pores and to expand existing pores.

Since metallic potassium vapor is very active, its direct contact with the air would induce explosion. In order to prevent possible explosions, nitrogen shall be injected during the entire activation process so that metallic potassium vapor is prevented from having direct contact with the air.

To further guarantee the safety of the system provided by the present invention, preferably, the activation furnace in the system of the present invention further comprises a second gas outlet. The second gas outlet is provided with an explosion-proof valve, and the above-mentioned nitrogen gas curtain is arranged at the inner side of the explosion-proof valve.

In this way, when the pressure in the activation furnace exceeds a certain limit, the explosion-proof valve automatically opens. Such an arrangement fulfills two functions: firstly, it serves to block the second gas outlet of the activation furnace when the gas pressure is small, acting as a barrier to prevent the gas in activation furnace from overflowing; secondly, it automatically opens when gas in the activation furnace drastically expands to exceed a certain limit (e.g. 3 kg) so as to prevent the activation furnace from bursting.

The nitrogen gas curtain is disposed at the inner side of the explosion-proof valve, and the nitrogen gas curtain and the explosion-proof valve form two barriers to prevent the gas in the activation furnace from overflowing, so that even the explosion-proof valve opens, the gas in the activation furnace still can not overflow under the block of the nitrogen gas curtain.

During the reaction process and after the reaction, the gas in the furnace is vented into the first recovery unit to be recovered. The absorption liquid (e.g. water) in the first recovery unit absorbs KOH vapor [symbol] K2CO3 vapor [symbol] K2O vapor and high temperature potassium vapor, so as to prevent these contaminative, corrosive, explosive hazardous gases from entering the atmosphere.

According to another embodiment of the present invention, the activation furnace is provided with a vertical gas conduit; the outlet at the top of the gas conduit is a second gas outlet; the second gas outlet is provided with an explosion-proof valve; a nitrogen gas inlet is provided at the side walls of the gas conduit, below the second gas outlet. The nitrogen gas inlet is disposed below the explosion-proof valve. The continuously vented high pressure nitrogen gas forms a nitrogen gas curtain at the nitrogen gas inlet.

According to another embodiment of the present invention, in the activation process, the petroleum coke is crushed to 60-100 mesh.

As another aspect of the present invention, a process is provided for the preparation of activated carbon from fly ash, including a flotation process for fly ash particle flotation and a carbonization process for carbonizing the charcoal powder raw material after the flotation, wherein the flotation process comprises the steps of:
1) adding a flotation agent to fly ash particles and forming a mixture,
2) allowing the mixture obtained in step 1) to fall from the upper part of a first flotation device,
3) forming upwardly blowing gas in the flotation device and making the gas contact countercurrent with the falling mixture of step 2), in which the gas is in a state of turbulent flow when moving upward, and
4) collecting particles which upwardly pass through the flotation plate of the first flotation device.

In step 1), a flotation agent or collecting agent is used, wherein the flotation agent used can be perpenic oil or C8 aromatics or any other types of flotation agent, and the collecting agent can be light diesel oil or diesel. The gas in step 3) has a pressure of, e.g. 1-2 atmospheres (gauge pressure).

Since the gas for upwardly driving the bubbles and particles are in a state of turbulent flow, more desirable flotation effect and higher flotation rate are achieved.

Meanwhile, the above-mentioned carbonization process comprises the steps of:
A. heating up charcoal powder raw material in a rotary cylinder of a carbonization furnace by a heating means, and generating combustible fuel gas under the heat,
B. switching off the heating means,
C. inletting fuel gas generated in step A into a combustion means for combustion and generating high temperature flue gas,
D. inletting the generated high temperature flue gas into the rotary cylinder to heat up charcoal powder raw material and then to generate combustible fuel gas,
E. inletting fuel gas generated in step D into the combustion means for combustion to generate high temperature flue gas, and
F. repeating step D and step E.

According to an embodiment of the present invention, in the flotation process the turbulent flow is formed by allowing the gas in the first flotation device to form multiple strands of gas flow in different upward angles. For example, a gas-diffuser can be disposed within the first flotation device. The surface of the gas-diffuser is formed with a plurality of air holes, the plurality of air holes being arranged to face obliquely upward in their respective angles, so that materials in the flotation device form a turbulent flow.

According to another embodiment of the present invention, particles which fail to pass upwardly through the flotation plates are conveyed to the vessel which contains the mixture in step 1), so that those particles that do not pass upwardly through the flotation plates enter the first flotation device again for another cycle of flotation, thereby enhancing the utilization rate of the raw material.

The above process can be called a first stage flotation. Carbon particles obtained in the first stage flotation can be used as raw materials for many purposes, such as the preparation of activated carbon. However, in order to obtain carbon particles of smaller size and greater fineness, carbon particles obtained by the first stage flotation process can undergo a second stage flotation to obtain finer raw materials for, e.g. the preparation of activated carbon. The second stage flotation comprises the steps of:
5) allowing the particles obtained in step 4) to fall from the upper part of a second flotation device;
6) forming upwardly blowing gas in the flotation device making the gas contact countercurrent ith particles falling in step 5) in which the gas is in a state of turbulent flow when moving upward, and
7) collecting particles which pass through the flotation plate of the flotation device in step 6).

The flotation device used in steps 1), 2), 3) and 4) is the first flotation device, while the flotation device used in steps 5), 6) and 7) is the second flotation device. The gas in step 6) has a pressure of, e.g. 1-2 atmospheres.

According to another embodiment of the present invention, between steps 4) and 5) there further comprises the steps of: adding a flotation agent and/or a collecting agent to the particles obtained in step 4), wherein the flotation agent is, for example, perpenic oil or C8 aromatics, and the collecting agent is, for example, light diesel oil or diesel.

According to another embodiment of the present invention, a reflecting face is provide in the flotation device, so that materials in the mixture that fall from the upper part and particles that pass downwardly through the flotation plate in step 5) have upward reflections. The reflecting face can be of various shapes, for example, a plane shape, a sphere shape or a cone shape with an upward tip.

According to another embodiment of the present invention, in the carbonization process, at the time when the charcoal powder raw material is heated, the cylinders are also rotated so that the charcoal powder raw material is kept tumbling and is thus uniformly heated.

According to another embodiment of the invention, in the carbonization process, the high temperature flue gas is having countercurrent contacts with the charcoal powder raw material. That is to say, the flow direction of the high temperature flue gas is opposite with the direction of translational motion of charcoal powder raw material.

According to another embodiment of the invention, in the carbonization process, the high temperature flue gas is having co-current contacts with the charcoal powder raw material. That is to say, the flow direction of the high temperature flue gas is the same with the direction of translational motion of charcoal powder raw material.

According to another embodiment of the present invention, in the carbonization process, the heating means is an electric heating pipe disposed at the central axis of the carbonization furnace.

According to another embodiment of the present invention, in the carbonization process, the angle between the sides and the central axis of the inner cylinder and the outer cylinder 8°-12°, more preferably 10°-11°.

According to another embodiment of the present invention, the process further comprises an activation process for activating the carbonized carbon power by alkali. This activation process goes after the carbonization process and comprises the steps of:
a) uniformly mixing potassium hydroxide with carbon powder (or referred as charcoal powder) at a weight ratio of 6-2:1 and placing the mixture into an activation furnace;
b) inletting nitrogen into the activation furnace to expel air out of the activation furnace and at the same time, by means of stage heating and stage heat preservation, raising the temperature to 700° C.-1000° C., preferably to 700° C.-900° C.;
c) introducing the gas generated in the activation furnace into a sealed vessel with water for water-seal recovery, in which the sealed vessel is further provided with a gas outlet for discharging after water-seal recovery treatment, and
d) cooling the activation furnace, and washing and drying the resulting product to obtain activated carbon with high specific surface area.

According to another embodiment of the present invention, in the activation process, the carbon powder comprises carbonized charcoal powder raw material and petroleum coke in a weight ratio of 2:8 to 8:2, preferably 3:7-7:3.

According to another embodiment of the present invention, in the activation process, gas which flows out of the sealed vessel after water-seal recovery is conducted is filtered to remove solid particles therein and is then evacuated.

According to another embodiment of the present invention, in the activation process, stage heating-heat preservation is carried out in three stages: the temperature is raised to 380° C.-440° C. in the first stage, and then heat is preserved; the temperature is raised to 480° C.-560° C. in the second stage, and then heat is preserved; the temperature is raised to 700° C.-900° C. in the third stage, and then heat is preserved.

According to another embodiment of the present invention, in the activation process, the rate of nitrogen inletting in step b) is so controlled that the air in the activation furnace has been substantially discharged when the temperature is raised to 100° C.-300° C., preferably to 100° C.-200° C., and more preferably to 100° C.-160° C.

According to another embodiment of the present invention, in the activation process, step d) lowers the temperature in the activation furnace down to 100° C.-200° C., preferably to 100° C.-160° C.

According to another embodiment of the present invention, in the activation process, the weight of ash contents in the carbonized charcoal powder is less than 3%.

Compared with the prior art, the invention has the following advantages:

Firstly, since a fuel gas-flue gas loop structure is provided, the combustible fuel gas generated during carbonization process enters the combustion means for combustion via this loop structure, and also via this loop structure, the high temperature flue gas generated by combustion enters the carbonization furnace to heat up the charcoal powder raw material in the carbonization furnace. This cycle of process is repeated and such a repeated cycle not only saves energy, but also prevents the substantial amounts of combustible gas from being emitted into the atmosphere, thereby reducing environmental pollution.

Secondly, since two cylinders are arranged in the carbonization furnace, the charcoal powder raw material in the inner cylinder enters the outer cylinder and then exits from the outer cylinder. In this way, with the length of the device unchanged, the route of the charcoal powder raw material is lengthened and its heating time is prolonged, allowing the raw material to be sufficiently heated and carbonized.

Thirdly, the inner cylinder and/or the outer cylinder of the carbonization furnace are arranged to be in the shape of a circular truncated cone, so that the charcoal powder raw material flows forward along the inner wall of the cylinders under gravitational force component so that the charcoal powder raw material is heated during its forward movement, thereby improving heating efficiency;

Finally, the walls of the inner cylinder and the outer cylinder in the carbonization furnace are provided with lifting plates, so that the charcoal powder raw material is effectively pushed forward.

The present invention will be further described in detail below with reference to the drawings.

### BRIEF DESCRIPTION OF THE DRAWINGS

FIG. 1 is a block diagram showing an embodiment of the present invention;

FIG. 2 is a schematic diagram showing an embodiment of the flotation system according to the present invention;

FIG. 3 is a schematic diagram showing an embodiment of a carbonization system according to the present invention;

FIG. 4 is a schematic diagram showing an embodiment of an activation system according to the present invention;

FIG. 5 is a schematic diagram of another embodiment of a flotation system according to the present invention.

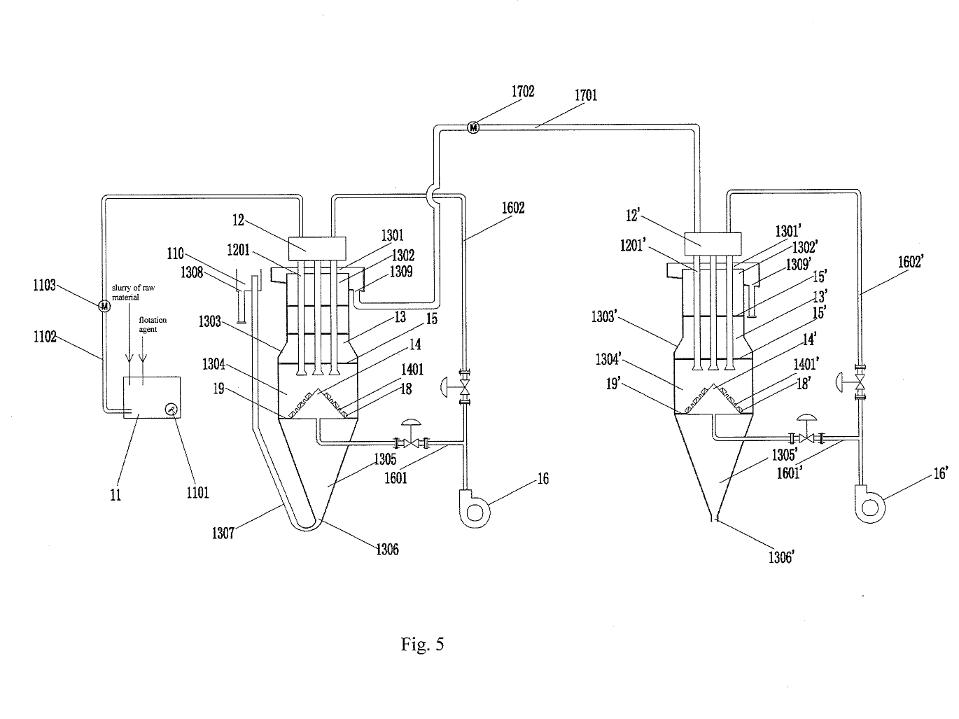

### DETAILED DESCRIPTION OF THE INVENTION

### Example 1

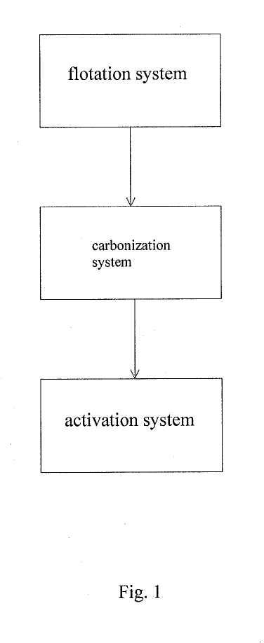

This embodiment of the present invention obtains carbon particles (i.e. charcoal powder raw material) by means of fly ash flotation. After these carbon particles are dried and granulated, they are carbonized, and the carbonized charcoal powder is then activated. This embodiment of the present invention comprises a flotation system, a carbonization system and an activation system (as shown in FIG. 1).

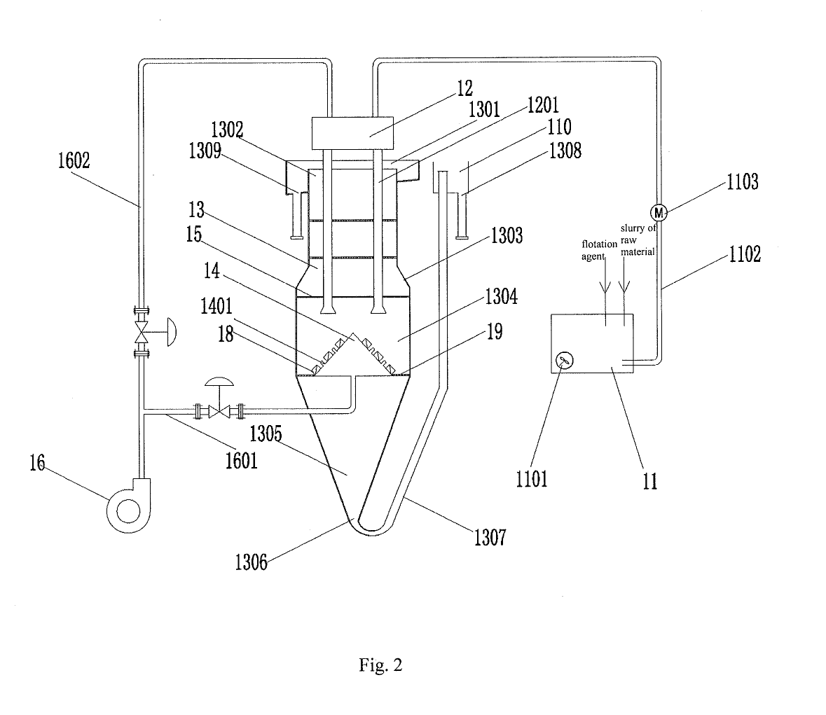

FIG. 2 is a flotation system according to this embodiment of the present invention. The flotation system comprises a flotation device. The flotation device comprises: a storage means 11, a dispensing means 12, a vertically arranged cylinder 13, a cone-shaped reflective gas-diffuser 14, multi-layer flotation plates 15, a gas supply means 16, a physical separation means (e.g. ultrasonic separation means) 18, a filter plate 19, a tailing tank 110, an overflow collection segment 1301, and a tailing collection segment 1305.

The vertically arranged cylinder 13 can be divided into three parts, which, from top to bottom in sequence are: a first flotation segment 1302, a divergent cone segment 1303, and a second flotation segment 1304. The first flotation segment 1302 is narrower and a layer of flotation plates 15 is disposed within first flotation segment 1302, while second flotation segment 1304 is wider, with one-shaped gas-diffuser 14 and a layer of flotation plates 15 disposed within second flotation segment 1304. Between first flotation segment 1302 and second flotation segment 1304 there is disposed with a cone-shaped transitional region having an upward tip.

Overflow collection segment 1301 is disposed outside first flotation segment 1302, and the top of first flotation segment 1302 is between the top and the bottom of overflow collection segment 1301. Furthermore, the bottom of the overflow collection segment 1301 is provided with a discharge port 1309.

Tailing collection segment 1305 is cone-shaped and has a downward tip, and the tip at its bottom is provided with a tailing outlet 1306. Tailing outlet 1306 is connected with a tailing pipe 307, and tailing pipe 1307 is in turn connected to tailing tank 110, and tailing tank 110 is disposed at the end of tailing pipe 1307 and sheathes tailing pipe 1307. The height of the end of tailing pipe 1307 is above the top layer of the flotation plates, and the end of the tailing pipe 1307 is provided with a fluid level adjusting means for adjusting fluid level within the flotation device. A tailing outlet 1308 is provided at the bottom of tailing tank 110. Between second flotation segment 1304 and tailing collection segment 1305, there is provided with filter plate 19.

Gas-diffuser 14 is in the shape of a cone with an upward tip and has a cone angle of about 120°. Its conic surface is formed with a plurality of air holes 1401. Gas-diffuser 14 is disposed within second flotation segment 1304, and is above cone-shaped tailing collection segment 1305. Gas-diffuser 14 is provided with a plurality of ultrasonic separation means 18.

Spaced multilayer (e.g. two) flotation plates 15 are respectively disposed within first flotation segment 1302 and second flotation segment 3104, and the bottom layer of flotation plates 15 is above cone-shaped gas-diffuser 14.

Dispensing means 12 is disposed above overflow collection segment 1301, and dispensing means 12 is a vessel, the lower part of which is provided with a plurality of (e.g. 8) dispensing pipes 1201. The ends of dispensing pipes 1201 are within second flotation segment 1304, between cone-shaped gas-diffuser 14 and the bottom layer of flotation plates 15.

A stirring unit 1101 is provided within storage means 11 for sufficiently stirring fly ash slurry and flotation agent. The lower part of storage means 11 is provided with a feed pipe 1102. Feed pipe 1102 is provided with a slurry pump 1103 and leads to dispensing means 12.

Gas supply means 16 is connected with a first gas conduit 1601 and a second gas conduit 1602, wherein first gas conduit 1601 is communicated with the plurality of air holes 1401 on cone-shaped gas-diffuser 14, while second gas conduit 1602 leads to dispensing means 12.

The operating principle of the flotation system is as follows: Since the main components of fly ash are carbon particles and ash content, after flotation agent and/or collecting agent and/or other additives are added, particles in the fly ash have contacts and collisions with the bubbles, and then carbon particles, which have good flotability, adhere to the bubbles, are carried to rise by the bubbles, and are thereby floated, while ash contents, which have poor flotability, would descend.

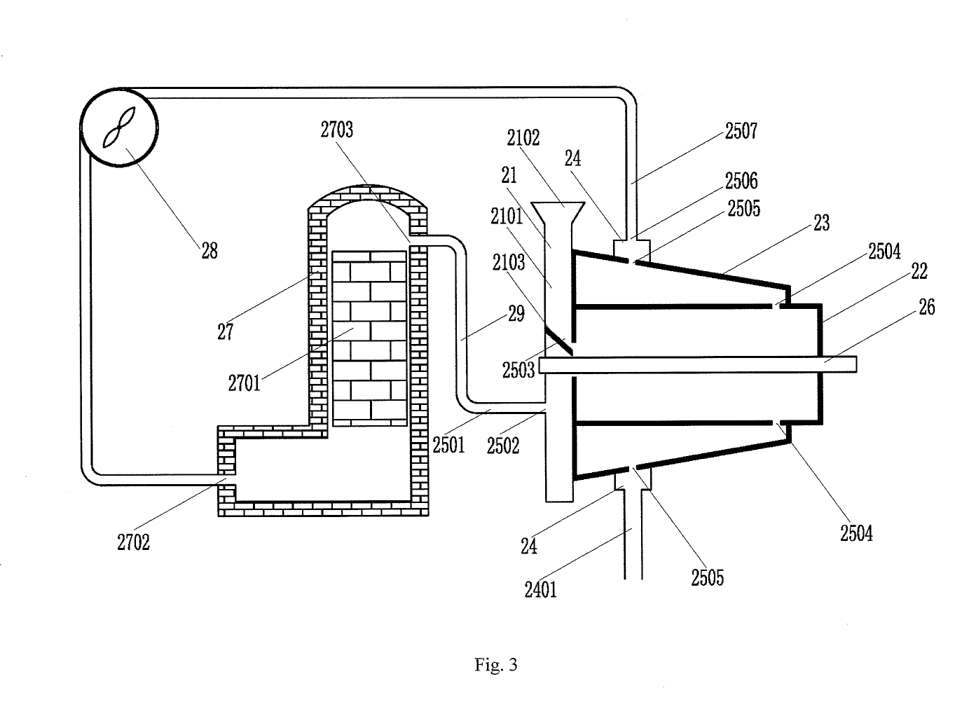

FIG. 3 is an embodiment of a carbonization system of the present invention. The carbonization system comprises a carbonization furnace and a combustion means such as a combustion furnace 27. The carbonization furnace comprises a feed means 21, a rotatable inner cylinder 22, a rotatable outer cylinder 23, a collection means 24, a fuel gas-flue gas loop structure 25, a heating means 26, a drive means (not shown) for driving the inner cylinder and the outer cylinder to rotate.

In this embodiment, inner cylinder 22 is a sealed cylinder with a horizontal axis and having a plurality of lifting plates (not shown) on its inner wall. A first opening 2503 is provided on the end face of the head portion of inner cylinder 22, while a plurality of second openings 2504 are provided at the side face of the end portion of inner cylinder 22, and the plurality of second openings 2504 are all formed on the same longitudinal cross section having an equal distance to the end of inner cylinder 22.

Feed means 21 is provided with a feed pipe 2101 which is communicated with the first opening 2503. The bottom of feed pipe 2101 is sealed while the top of feed pipe 2101 is provided with a feed inlet 2102. A slanted baffle 2103 which points to first opening 2503 is arranged in feed pipe 2101. A fifth opening 2502 is provided at the sidewall of feed pipe 2101, below first opening 2503. Fifth opening 2502 is communicated with first gas conduit 2501 of the combustion means.

Outer cylinder 23 is in the shape of a sealed circular truncated cone, with its axis coincides with the axis of inner cylinder 22. The angle between the side edge and the central axis of outer cylinder 23 is 10°. Inner cylinder 22 is sheathed by outer cylinder 23. The plurality of second openings 2504 of inner cylinder 22 are all sheathed by outer cylinder 23. The narrower head portion of outer cylinder 23 is adjacent to the end portion of inner cylinder 22 while the wider end portion of outer cylinder 23 is adjacent to the head portion of inner cylinder 22. A plurality of lifting plates (not shown) are provided on the inner wall of outer cylinder 23. The side edge of outer cylinder 23 is provided with a plurality of third openings 2505, all of which are formed on the same longitudinal section having an equal distance to the end of the outer cylinder 23.

Collection means 24 sheathes outer cylinder 23 and all third openings 2505 therein. At the top of the external wall of collection means 24 there is a fourth opening 2506. Fourth opening 2506 is communicated with second gas conduit means 2507 of the combustion means. A discharge pipe 2401 is provided at the bottom of collection means 24.

Fuel gas-flue gas loop structure 25 comprises first gas conduit 2501, fifth opening 2502, first opening 2503, second opening 2504, third opening 2505, fourth opening 2506 and second gas conduit 2507.

Heating means 26 is an electric heating tube in the shape of a shaft disposed at the axis of inner cylinder 22.

Combustion furnace 27 comprises a gitter brick 2701 within the combustion furnace, a gas inlet 2702 below combustion furnace 27, a gas outlet 2703 above combustion furnace 27. Gas inlet 2702 of combustion furnace 27 is connected the other end of the second gas conduit 2507. A gas pump 28 is provided at the intermediate part of the second gas conduit 2507. The other end of the first conduit 2501 is connected with gas outlet 2703 of the combustion furnace.

The workflow of the carbonization system is as follows:

1. Charcoal powder raw material. The floated carbon particles serve as charcoal powder raw material to enter feed pipe 2101 from feed inlet 2102. After being blocked by baffle 2103, the charcoal powder raw material enters inner cylinder 22 from first opening 2503. Driven by the drive means, the inner cylinder 22 and the outer drum 23 rotate to drive the lifting plates which are disposed on the inner walls of inner cylinder 22 and outer cylinder 23 to rotate, pushing the charcoal powder raw material towards the direction of second opening 2504. In its forward movement, the charcoal powder raw material has contacts with the heating means 26 in inner cylinder 22 or with the high temperature flue gas, and is thereby heated. The charcoal powder raw material falls into outer cylinder 23 from second opening 2504, and was pushed towards the direction of third opening 2505 by the rotating lifting plates. In the process of its movement, the charcoal powder raw material is heated, dried, pyrolyzed, and finally carbonized. The carbonized charcoal powder raw material then falls into the collection means 24 which sheathes outer cylinder 23, and exits from the carbonization furnace via discharge pipe 2401.
2. Fuel gas-flue gas. In this embodiment, the fuel gas-flue gas have co-current contacts with the charcoal powder raw material. Under the thermal effect of the heating means 26, charcoal powder raw material within inner cylinder 22 then generates a combustible fuel gas. Along the flow direction of the charcoal powder raw material, the combustible fuel gas flows into outer cylinder 23 via second opening 2504, and then via third openings 2505, fourth opening 2506 and second gas conduit 2507, enters combustion furnace 27. After the combustion, the combustible gas generates high temperature flue gas in combustion furnace 27. Via first gas conduit 2501, fifth opening 2502 and first opening 2503, the high temperature flue gas enters inner cylinder 22. Under the thermal effect of high temperature flue gas, charcoal powder raw material within inner cylinder 22 generates combustible fuel gas, and the above process is repeated.

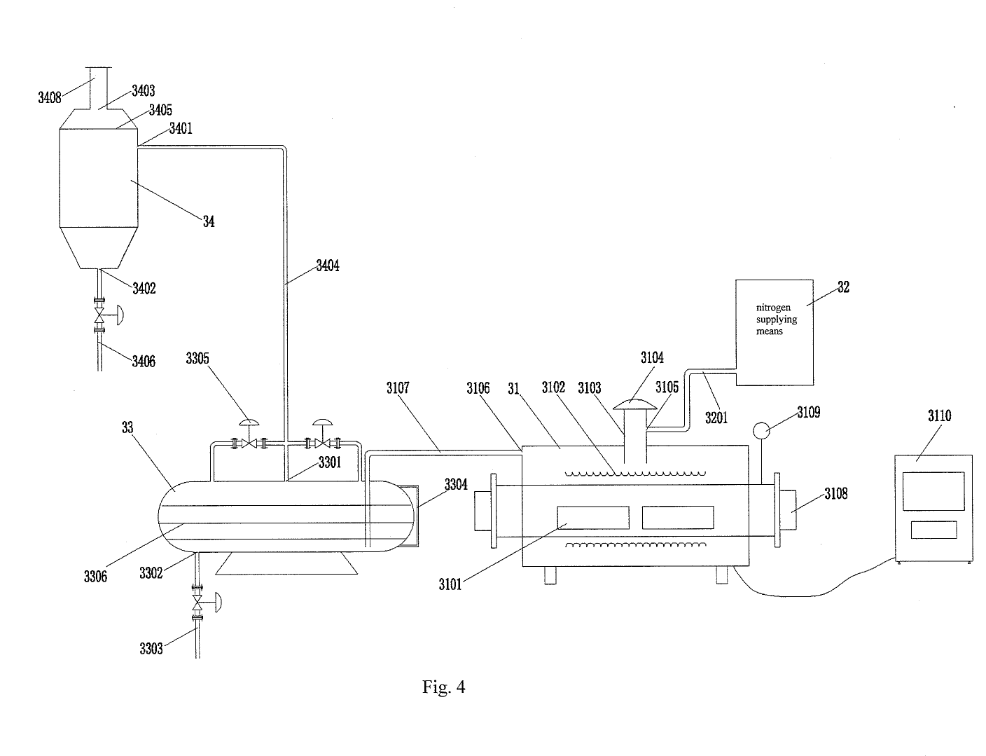

FIG. 4 shows an example of an activation system in the present embodiment, the activation system comprising an activation furnace 31, a nitrogen gas supply means 32, a first recovery unit 33, and a second recovery unit 34.

In this embodiment, activation furnace 31 is a sealed vessel, in which a vessel for holding raw materials such as a nickel crucible 3101, and a heating means such as a plurality of electric heating wires 3102 are provided. The top of activation furnace 31 is arranged with a vertical gas conduit 3103. The outlet at the top of gas conduit 3103 is the first gas outlet. An explosion-proof valve 3104 is provided at the first gas outlet. When the drastic expansion of the gas in the activation furnace exceeds a certain limit, the explosion-proof valve 3104 automatically opens. An nitrogen gas inlet 3105 is provided on the sidewall of gas conduit 3103, below the first gas outlet. A second gas outlet 3106 is provided at the furnace body of activation furnace 31. Second gas outlet 3106 is connected with a second connection conduit 3107. Activation furnace 31 is an intermittent activation furnace, the side face of which is provided with an openable end cover 3108. A water cooling pipe (not shown) for conveying cooling water is provided at the end cover. A pressure gauge 3109 is provided on activation furnace 31 for showing the pressure within the furnace. Activation furnace 31 further comprises a heating control cabinet 3110 for controlling an electrical heating wire 3102 to achieve precise control of the heating temperature and the heating time.

Nitrogen gas supply means 32 is communicated with the nitrogen gas inlet 3105 in activation furnace 31 via a first connection conduit 3201.

First recovery unit 33 is a sealed vessel, in which absorption liquid 3306 is provided. Second connection conduit 3107 is inserted into first recovery unit 33 and extends below the liquid level of absorption liquid 3306. A gas outlet 3301 is provided above absorption liquid 3306, at the top of the first recovery unit 33. The bottom of first recovery unit 33 is provided with an recovery liquid outlet 3302 and a first recovery pipe 3303 which is connected with recovery liquid outlet 3302. A valve is provided at first recovery pipe 3303. First recovery unit 33 is provided with a water level gauge 3304 for measuring water level within the recovery unit. First recovery unit 33 is also provided with a pressure control valve 3305 for regulating pressure within activation furnace 31.

Second recovery unit 34 is a sealed vessel which is provided with a feed inlet 3401, a material recovery port 3402, a gas outlet 3403, and a filter screen 3405. Feed inlet 3401 is provided at the sidewall of the second recovery unit 34, below filter screen 3405, and is communicated with gas outlet 3301 of first recovery unit 33 via a third connection conduit 3404. Material recovery port 3402 is disposed at the bottom of second recovery unit 34. Gas outlet 3403 is provided at the top of the second recovery unit 34, above filter screen 3405. Gas outlet 3403 is, from its outside, connected with a gas discharge pipe 3408. Third connection conduit 3404 is longer, so that while gas in the first recovery unit 33 is passing through the third connection conduit 3404, there is sufficient time for the gas to cool down. Second recovery pipe 3406 is connected with material recovery port 3402, and second recovery pipe 3406 is provided with a valve.

### Example 2

Most part of this exemplary embodiment is similar to Example 1, with the difference being, flotation system of this example comprises two flotation devices, i.e. a second flotation device is arranged after a first flotation device. The second flotation device comprises: a dispensing means 12′, a vertically arranged cylinder 13′, a cone-shaped reflective gas-diffuser 14′, multi-layer flotation plates 15′, a gas supply means 16′, a physical separation means (e.g. ultrasonic separation means) 18′, a filter plate 19′, an overflow collection segment 1301′, a tailing collection segment 1305′.

The vertically arranged cylinder 13′ can be divided into three parts, which, from top to bottom in sequence are: a first flotation segment 1302′, a divergent cone segment 1303′, and a second flotation segment 1304′First flotation segment 1302′ is narrower and a layer of flotation plates 15′ is disposed within first flotation segment 1302′. Second flotation segment 1304′ is wider, with cone-shaped gas-diffuser 14′ and a layer of flotation plates 15′ disposed within second flotation segment 1304′. Between first flotation segment 1302′ and second flotation segment 1304′ there is disposed with a cone-shaped transitional region having an upward tip.

Overflow collection segment 1301′ is wider than first flotation segment 1302, and sheathes first flotation segment 1302′, and the top of first flotation segment 1302′ is disposed between the top and the bottom of overflow collection segment 1301′. Furthermore, the bottom of the overflow collection segment 1301′ is provided with a discharge port 1309′.

Tailing collection segment 1305′ is cone-shaped and has a downward tip, and the tip at its bottom is provided with a tailing outlet 1306′. Between second flotation segment 1304′ and tailing collection segment 1305′, there is provided with filter plate 19′.

Gas-diffuser 14′ is in the shape of a cone with an upward tip and has a cone angle of about 120°. Its conic surface is formed with a plurality of air holes 1401′. Gas-diffuser 14′ is disposed within second flotation segment 1304′, and is above cone-shaped tailing collection segment 1305′. Gas-diffuser 14′ is provided with a plurality of ultrasonic separation means 18′.

Spaced multilayer (e.g. two) flotation plates 15′ are respectively disposed within first flotation segment 1302′ and second flotation segment 3104′, and the bottom layer of flotation plates 15′ is above cone-shaped gas-diffuser 14′.

Dispensing means 12′ is disposed above overflow collection segment 1301, and dispensing means 12′ is a vessel, the lower part of which is provided with a plurality of (e.g. 8) dispensing pipes 1201′. The ends of dispensing pipes 1201′ are within second flotation segment 1304′ and are between cone-shaped gas-diffuser 14′ and the bottom layer of flotation plates 15′.

Discharge port 1309 of the first flotation device is connected with a discharge pipe 1701, the other end of discharge pipe 1701 leading to dispensing means 12′ of a second flotation device.

Gas supply means 16′ is connected with a first gas conduit 1601′ and a second gas conduit 1602′. First gas conduit 1601′ is communicated with the plurality of air holes 1401′ on cone-shaped gas-diffuser 14′, while second gas conduit 1602′ leads to dispensing means 12′.

The workflow of this flotation system can be divided into two stages: a first stage in the first flotation device and a second stage in the second flotation device.

The first stage is as follows: adding a flotation agent into the fly ash raw material slurry in storage means 11 to form a mixture. The mixture enters dispensing means 12 via feed pipe 1102 disposed at the lower part of storage means 11. The mixture containing fly ahs raw material and flotation agent in dispensing means 12 enters the cylinder via the plurality of dispensing pipes 1201 disposed at the lower part of dispensing means 12. Gas supply means 16 supplies gas into the cylinder via air holes 1401 disposed on gas-diffuser 14. Under the effect of the flotation agent, the carbon particles adhere to the bubbles, diffuse and move upwardly in a state of turbulent flow, pass through the holes on the layers of flotation plates 15, and fall on the uppermost layer of flotation plates 15, so that flotation of carbon particles is achieved. In the meantime, ash contents, which have poor flotability, fail to pass through flotation plates 15 and fall to tailing collection segment 1305. The floated carbon particles then are collected into overflow collection segment 1301. From discharge port 1309, these carbon particles enter dispensing means 12′ of the second flotation device via discharge pipe 1701 for a second stage flotation.

The second stage flotation is a further flotation process using those floated carbon particles in the first stage as a raw material, so as to produce particles with greater carbon contents. The workflow of the second stage flotation is similar to the first stage flotation. Specifically, it comprises the steps of: particles in dispensing means 12′ enter the cylinder via the plurality of dispensing pipes 1201′ disposed at the lower part of dispensing means 12′. Gas supply means 16′ supplies gas into the cylinder via air holes 1401′ disposed on gas-diffuser 14′. Under the effect of the flotation agent, the carbon particles adhere to the bubbles, diffuse and move upwardly in a state of turbulent flow, pass through holes on the layers of flotation plates 15′, and fall on the uppermost layer of flotation plates 15′, so that flotation of carbon particles is achieved. The floated carbon particles then are collected into overflow collection segment 1301′. Ash contents, which have poor flotability, fail to pass through flotation plates 15′ and thus fall to tailing collection segment 1305′, and are discharged from tailing outlet 1306′.

Although a few preferable embodiments of the present invention have been described in detail above, they are not intended to limit the scope of the embodiments of the present invention. Those skilled in the art will readily appreciate that many modifications are possible in the embodiments without materially departing from the scope of the present invention. Accordingly, all equivalent modifications made according to disclosure of the present application shall be included within the scope of this disclosure.

1. A system for preparing activated carbon from fly ash, comprising a flotation system and a carbonization system,
wherein the flotation system comprises at least one flotation device and each of said flotation device comprises a vertically arranged cylinder, an overflow collection segment disposed at the top of the cylinder and a tailing collection segment disposed at the bottom of the cylinder, in which said overflow collection segment is provided with a discharge port and said tailing collection segment is provided with a tailing outlet, and
wherein the carbonization system comprises:
a combustion means comprising a gas inlet and a gas outlet,
a double-cylinder rotary carbonization furnace, which comprises a rotatable inner cylinder and a rotatable outer cylinder, a heating means disposed in the inner cylinder, a drive means for driving said inner cylinder, and said outer cylinder to rotate, wherein said inner cylinder is sheathed by said outer cylinder, and
a fuel gas-flue gas loop structure, in which the fuel gas produced from the heated charcoal powder raw material in the carbonization furnace is conveyed to the combustion means for combustion and the flue gas produced by the fuel gas is used to heat up the charcoal powder raw material, wherein the loop structure comprises a plurality of openings arranged at the carbonization furnace and a gas conduit for connecting said carbonization furnace to said combustion means.

2. The system according to claim 1, wherein said flotation device further comprises:
a gas-diffuser disposed within said cylinder, wherein the gas-diffuser is formed with a large surface for reflecting bubbles and particles and the surface of the gas-diffuser is formed with a plurality of air holes which is arranged to respectively form different angles with the horizontal plane,
spaced multiple-layer flotation plates in said cylinder, wherein the bottom layer of the flotation plates is disposed above the gas-diffuser,
a dispensing means disposed above said overflow collection segment, wherein said dispensing means is form of a vessel having a plurality of dispensing pipes at its lower part or bottom with the ends of the dispensing pipes being arranged between said gas-diffuser and the bottom layer of said flotation plates, and
a gas supply means which is communicated with a plurality of air holes on said gas-diffuser via a first gas conduit.

3. The system according to claim 2, wherein said gas-diffuser in said at least one flotation device is cone-shaped with an upward tip and said plurality of air holes is formed on the conic surface of said gas-diffuser.

4. The system according to claim 2,
wherein in said at least one flotation device, said cylinder comprises a narrower first flotation segment in the upper part of said cylinder and a wider second flotation segment in the lower part of said cylinder, and said overflow collection segment is disposed outside the first flotation segment, and
wherein between said first flotation segment and said second flotation segment there is disposed with a divergent cone segment as a transitional region, and the divergent cone segment is disposed above the bottom layer of the flotation plates.

5. The system according to claim 2, wherein said flotation system comprises two flotation devices, in which the discharge port of the first flotation device is provided with a discharge pipe, and said discharge pipe is connected to the second flotation device.

6. The system according to claim 1, wherein said plurality of openings at the carbonization furnace comprise a first opening at the head portion of the inner cylinder of said carbonization furnace, a second opening at the end portion of the inner cylinder of said carbonization furnace, and a third opening at the end portion of the outer cylinder of said carbonization furnace, in which said second opening is sheathed by the outer cylinder.

7. The system according to claim 6, wherein said gas conduit comprises a first gas conduit which is communicated with said first opening and a second gas conduit which is communicated with said third opening, in which the other end of said first gas conduit leads to the gas inlet or gas outlet of the combustion means, and the other end of said second gas conduit leads to the gas outlet or gas inlet of the combustion means.

8. The system according to claim 1, wherein said system further comprises an activation system which follows after the carbonization system, said activation system comprising:
a nitrogen supply means, wherein said nitrogen supply means is communicated with the nitrogen gas inlet of the activation furnace via a first connection conduit,
an activation furnace, wherein said activation furnace is a sealed vessel with a heating means, in which said activation furnace comprises a first gas outlet and a nitrogen gas inlet, said nitrogen gas inlet is formed with a nitrogen gas curtain, and said first gas outlet is connected to a second connection conduit, and
a first recovery unit, wherein said first recovery unit is a sealed vessel with absorption liquid, in which said second connection conduit is inserted into the first recovery unit and extends below the liquid level of the absorption liquid, and a gas outlet is provided above the liquid level of the absorption liquid.

9. The system according to claim 8, wherein said activation furnace in said activation system further comprises a second gas outlet, in which the second gas outlet is provided with an explosion-proof valve, and said nitrogen gas curtain is arranged at the inner side of the explosion-proof valve.

10. The system according to claim 8, wherein said activation furnace of said activation system is provided with a vertical gas conduit, in which the outlet at the top of said gas conduit is built as said second gas outlet, and said nitrogen gas inlet is provided at the side walls of said gas conduit and below said second gas outlet.

11. A process for preparing activated carbon from fly ash, comprising a flotation process for fly ash particle flotation and a carbonization process for carbonizing the floated charcoal powder raw material,
wherein said flotation process comprises the steps of:
1) adding a flotation agent to fly ash raw material and forming a mixture,
2) allowing the mixture obtained in step 1) to fall from the upper part of a flotation device,
3) forming upwardly blowing gas in the flotation device and making the gas contact countercurrent with the falling mixture of step 2) in which the gas is in a state of turbulent flow when moving upward, and
4) collecting particles which upwardly pass through the flotation plate of said flotation device, and
wherein said carbonization process comprises the steps of:
A. heating up charcoal powder raw material in a rotary cylinder of a carbonization furnace by a heating means with the charcoal powder raw material generating combustible fuel gas under the heat,
B. switching off the heating means,
C. inletting fuel gas generated in step A into a combustion means for combustion and generating high temperature flue gas,
D. inletting the generated high temperature flue gas into the rotary cylinder to heat up the charcoal powder raw material and then to generate combustible fuel gas,
E. inletting fuel gas generated in step D into the combustion means for combustion to generate high temperature flue gas, and
F. repeating step D and step E.

12. The process according to claim 11, wherein during said flotation process, said state of turbulent flow is formed by allowing said gas in said flotation device to form multiple strands of gas flow in different upward angles.

13. The process according to claim 11, wherein said flotation process further comprises the steps of:
5) allowing the particles obtained in step 4) to fall from the upper part of a flotation device,
6) forming upwardly blowing gas in the flotation device and making the gas contact countercurrent with particles falling in step 5) in which the gas is in a state of turbulent flow when moving upward, and
7) collecting particles which pass through the flotation plate of the flotation device in step 6).

14. The process according to claim 11, wherein during said carbonization process, at the time when said charcoal powder raw material is heated, said cylinders are rotated so that said charcoal powder raw material tumbles.

15. The process according to claim 11, wherein after said carbonization process, the process further comprises an activation process for activating the carbonized charcoal power, in which said activation process comprises the steps of:
a) uniformly mixing potassium hydroxide with the carbonized charcoal powder at a weight ratio of 6-2:1 and placing the mixture into an activation furnace;
b) inletting nitrogen into the activation furnace to expel air out of the activation furnace and at the same time, by means of stage heating and stage heat preservation, raising the temperature to 700° C.-1000° C., preferably to 700° C.-900° C.;
c) introducing the gas generated in the activation furnace into a sealed vessel with water for water-seal recovery, in which said sealed vessel is further provided with a gas outlet for discharging the gas produced after the water-seal recovery treatment, and
d) cooling the activation furnace, and washing and drying the resulted product to obtain activated carbon with high specific surface area.

16. A zero-emission double-cylinder rotary carbonization furnace for preparing activated carbon from fly ash, comprising: a rotatable inner cylinder and a rotatable outer cylinder, a heating means disposed in the inner cylinder, and a drive means for driving the inner cylinder and the outer cylinder to rotate, wherein the inner cylinder is sheathed by the outer cylinder, said carbonization furnace further comprises a fuel gas-flue gas loop structure, the fuel gas produced from the heated charcoal powder raw material in the carbonization furnace is conveyed to the combustion means for combustion, and the flue gas generated by the fuel gas is in turn used to heat up charcoal powder raw material.

17. The carbonization furnace according to claim 16, wherein said fuel gas-flue gas loop structure comprises a first opening at the head portion of the inner cylinder, a second opening at the end portion of the inner cylinder, and a third openings at the end portion of the outer cylinder, in which said second openings is sheathed by the outer cylinder.

18. The carbonization furnace according to claim 16, further comprising a collection means, wherein said collection means sheathes said outer cylinder and the third opening therein, in which the external wall of the collection means is provided with a fourth opening.

19. The carbonization furnace according to claim 16, further comprising a plurality of lifting plates arranged on the inner walls of the inner cylinder and/or the outer cylinder.

20. The carbonization furnace according to claim 19, wherein said plurality of lifting plates are in a spiral arrangement on the inner walls of said inner cylinder and said outer cylinder.
